(19) United States
(12) Patent Application Publication
(10) Pub. No.: US 2003/0236711 A1
(43) Pub. Date: Dec. 25, 2003

(54) E-marker dot promotion

(75) Inventor: Yuichiro Deguchi, San Mateo, CA (US)

Correspondence Address: VALLEY OAK LAW, 5655 SILVER CREEK VALLEY ROAD, # 106, SAN JOSE, CA, 95138, US

(73) Assignees: Sony Corporation; Sony Electronics Inc.

(21) Appl. No.: 10/180,612

(22) Filed: Jun. 25, 2002

(51) Int. Cl. G06F 17/60

(52) U.S. Cl. 705/26

(57) ABSTRACT

Method and system for providing a discount promotion offer from vendors for the purchase of items such as music CDs and related merchandise corresponding to bookmarked data using electronic music marker device such as broadcast music clips, the discount promotion offers each having a corresponding predetermined validity time period during which the purchase transaction of the underlying item must be completed in order for the discount to be valid is shown.

### BACKGROUND OF THE INVENTION

1. Field of the Invention

The present invention relates to electronic music marker devices. More particularly, the present invention relates to method and system for providing a time sensitive merchandise sales discount promotion for items corresponding to marked music clips such as music CDs and related merchandise.

2. Description of the Related Art

Sony Corporation and its U.S. subsidiary, Sony Electronics, Inc., introduced an electronic music marker device (“e-marker”) which is capable of “bookmarking” a music clip while being played on a radio and, which, when synchronized with a gateway device such as a personal computer, is capable of recalling information related to the bookmarked music clip such as the name of the song, the artist, the album containing the song and so on. Using the e-marker, a user can conveniently recall the music clip information that the user listened to on the radio at a later time without the need to memorize the information or wait hopefully for the disc jockey on the radio to provide that information. In this manner, if the user wants to, for example, purchase the music album which the user has marked using the e-marker, the user can easily identify the necessary information related to the marked music clip from the e-marks provided by the e-marker.

To download or obtain information corresponding to the bookmarked music clips, the user sets up an e-marker account via the gateway device, and connects the music marker device to the server terminal of emarker.com web site. The information corresponding to the bookmarked music clips such as the name of the artist, the name of the song as well as the name of the album, for example, are transmitted from the server terminal to the user's gateway device for display thereon.

Once logged onto the user's e-marker account via the user's gateway terminal (device), in addition to the information related to bookmarked music clips, the user may be provided with information corresponding to the purchase of the music album or related merchandise pertaining to the bookmarked music clip or the music clip artist, such as tee-shirts, music video cassettes, and the like. Given the increasing number of on-line vendors who offer for sale such items, and given that a large number of vendors periodically offer discounts for the purchase of such items, it would be desirable to provide discount information conveniently to the user for items corresponding to the user's bookmarked music clips.

### SUMMARY OF THE INVENTION

In view of the foregoing, a method in one embodiment includes transmitting one or more data marks, and receiving one or more promotion information corresponding to said one or more data marks.

A method of another embodiment includes connecting to a data network, transmitting login information and a data mark, receiving a promotion information for an item corresponding to transmitted data mark, and transmitting a payment information.

A method of yet another embodiment includes receiving a user login data and a data mark, retrieving a promotion information corresponding to said received data mark, and transmitting said retrieved promotion information.

A method of still a further embodiment includes detecting a user login request, receiving one or more data marks, retrieving promotion information based on said data marks corresponding to a purchase of an item, transmitting said retrieved promotion information, and starting a timer corresponding to said retrieved promotion information.

A data marking device vendor promotion system of still yet another embodiment includes a data network, a user terminal coupled to the data network configured to transmit a login data and a data mark, and a server terminal coupled to a data network configured to access one or more storage units in response to said data mark received from said user terminal, and to retrieve and transmit a promotion information corresponding to said data mark to said user terminal.

A data marking device vendor promotion system of a further aspect of the present invention includes means for detecting a user login request, means for receiving one or more data marks, means for retrieving promotion information based on said data marks corresponding to a purchase of an item, and means for transmitting said-retrieved promotion information.

A program storage device readable by a machine, tangibly embodying a program of instructions executable by the machine to perform method steps for providing a data marking device vendor promotion in yet a further aspect, where the method steps include detecting a user login request, receiving one or more data marks, retrieving promotion information based on said data marks corresponding to a purchase of an item, and transmitting said retrieved promotion information.

These and other features and advantages of the present invention will be understood upon consideration of the following detailed description of the invention and the accompanying drawings.

### BRIEF DESCRIPTION OF THE DRAWINGS

FIG. 1 illustrates an overall e-marker dot promotion system in accordance with one embodiment;

FIG. 2 illustrates a block diagram of the electronic bookmarking device shown in FIG. 1;

FIG. 3 illustrates an electronic music marker device and cradle-type docking connection;

FIG. 4 is one embodiment of a database illustration of the bookmarks in a storage unit of the electronic music marker device;

FIG. 5 is a flowchart for illustrating one embodiment of the electronic music marker device operation;

FIG. 6 is a flowchart for illustrating one embodiment of downloading data from the user's e-marker account to the music marker device;

FIG. 7 illustrates one embodiment of a user terminal of the e-marker dot promotion system shown in FIG. 1;

FIG. 8 illustrates one embodiment of the server terminal of the e-marker dot promotion system shown in FIG. 1;

FIG. 9 illustrates one embodiment of a user account database of the server terminal database storage unit shown in FIG. 8;

FIG. 10 illustrates one embodiment of a playlist database of the server terminal data storage unit shown in FIG. 8;

FIG. 11 illustrates one embodiment of a user playlist database of the server terminal data storage unit shown in FIG. 8;

FIG. 12 illustrates one embodiment of a coupon database of the server terminal data storage unit shown in FIG. 8;

FIG. 13 illustrates a flowchart for illustrating a dot promotion processing of one embodiment;

FIG. 14 illustrates a flowchart for illustrating a dot promotion processing of another embodiment;

FIG. 15 illustrates a flowchart for illustrating a dot promotion processing a further embodiment;

FIG. 16 illustrates a flowchart for illustrating a dot promotion processing of yet another embodiment;

FIG. 17 illustrates a flowchart for illustrating a dot promotion processing of still a further embodiment;

FIG. 18 is a graphical illustration of a user terminal display unit illustrating a dot promotion coupon offer in one embodiment;

FIG. 19 is a graphical illustration of a user terminal display unit illustrating detailed dot promotion coupon information in one embodiment; and

FIG. 20 is a graphical illustration of a user terminal display unit illustrating bookmarked music clip album dot promotion coupons in one embodiment.

### DETAILED DESCRIPTION

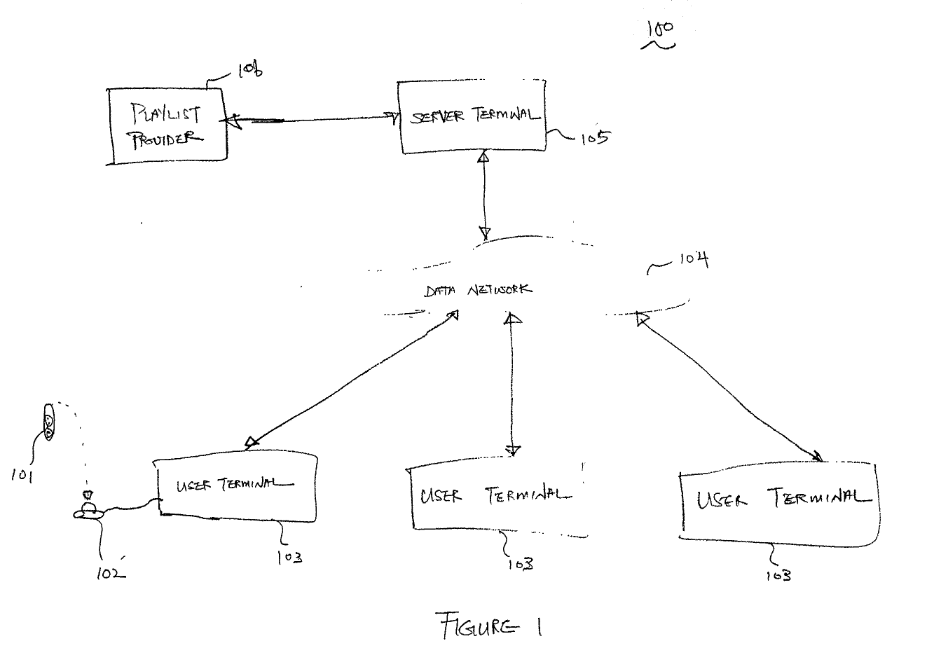

FIG. 1 illustrates an overall e-marker dot promotion system in accordance with one embodiment. Referring to FIG. 1, e-marker dot promotion system 100 includes a plurality of user terminals 103 each connected to data network 104 such as the internet via connection protocols such as TCP/IP, Appletalk, using connection interface unit (not shown) such as a dial-up modem through an internet service provider (ISP), a broadband network such as a DSL or cable modem, a T1 or LAN connection, or any other means for connecting to the internet. Each user terminal 103 is configured to connect to an electronic music marker device 101 via a cradle type connection unit 102, and configured to receive, upon synchronization operation with music marker device 101, bookmark information stored in music marker device 101. In one embodiment, the bookmark information transmitted from music marker device 101 to user terminal 103 may include music marker device 101 unique device identification code, the number of stored bookmarks, and corresponding date and time stamp for each stored bookmarks.

Also shown in FIG. 1 is server terminal 105 connected to data network 104 for communicating with user terminals 103 for data transfer. Moreover, as further shown in FIG. 1, server terminal 105 is coupled to playlist provider 106. Playlist provider 106 is configured to transmit playlist information corresponding to registered radio station broadcasts such as the title, artist and album information for the music broadcast from the registered radio station. In one aspect, playlist provider may be configured to periodically transmit information related to the music broadcast from the registered radio stations over a predetermined period of time. For example, depending upon factors such as the target market for the registered radio station or the geographic location of the registered radio station, playlist provider 106 may be configured to transmit broadcast music clip information to server terminal 105 within ten minutes from the termination of the respective music broadcast, or alternatively, within 12 or 24 hours from a predetermined broadcast cutoff time such as 10 PM or midnight. Moreover, while playlist provider 106 is shown as communicating with server terminal 105 via a dedicated connection, within the scope of the present invention, server terminal 105 and playlist provider 106 may communicate via a connection through data network 104 for data transfer.

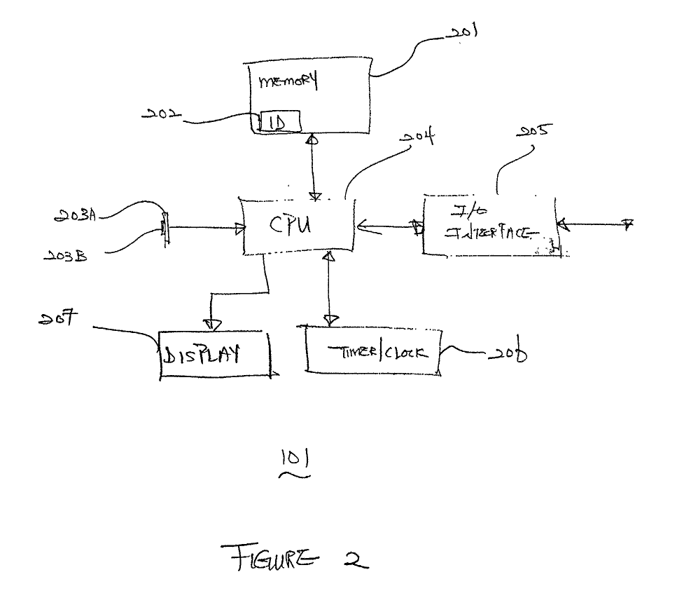

FIG. 2 illustrates a block diagram of the electronic music marker device shown in FIG. 1. Referring to FIG. 2, music marker device 101 includes memory 201 such as a Random Access Memory (RAM) and a Read-Only Memory (ROM), and stored thereon is a unique bookmarking device identification code 202 which can include a predetermined combination of letters or numbers, or a combination of both. In one embodiment, identification code 202 can include a thirteen-digit number which is unique to each bookmarking device and is pre-stored in the ROM portion of memory 201.

Further shown in FIG. 2 is controller (CPU) 204 which is configured to control the various components of bookmarking device 101 as shown such as display unit 207, input units 203A, 203B such as bookmarking buttons for bookmarking broadcast music clips over a registered radio or television station, or for bookmarking locations, input/output (I/O) interface 205, clock/timer 206, and memory 201. As can be seen from FIG. 2, upon receiving an input signal from a user of music marker device 101 via input units 203A, 203B, controller 204 may be configured to access the various components of device 101 depending upon the input command received from the user, to perform one or a plurality of processings, executing the input command of the user.

Moreover, I/O interface 205 of music marker device 101 shown in FIG. 2 may be configured to, under the control of controller 204, interface with server terminal 105. Display unit 207 in accordance with one embodiment of the present invention may include a liquid crystal display (LCD), a plasma-type display, and the like, configured to display text or image data, or a combined text and image data. Furthermore, as discussed above, the input unit 203A, 203B may include spring-loaded type input buttons for operation by the user's finger. Alternatively, input unit 203A, 203B may include a touchpad-type screen integrated with display unit 207 for simultaneously inputting and displaying information, where the user can tap the pressure-sensitive screen using a stylus or the like to enter input commands. Timer/clock 206 of music marker device 101 in accordance with one aspect of the present invention may be configured to provide actual time information as well as generate an elapsed time information depending upon the input command from the user under the control of controller 204.

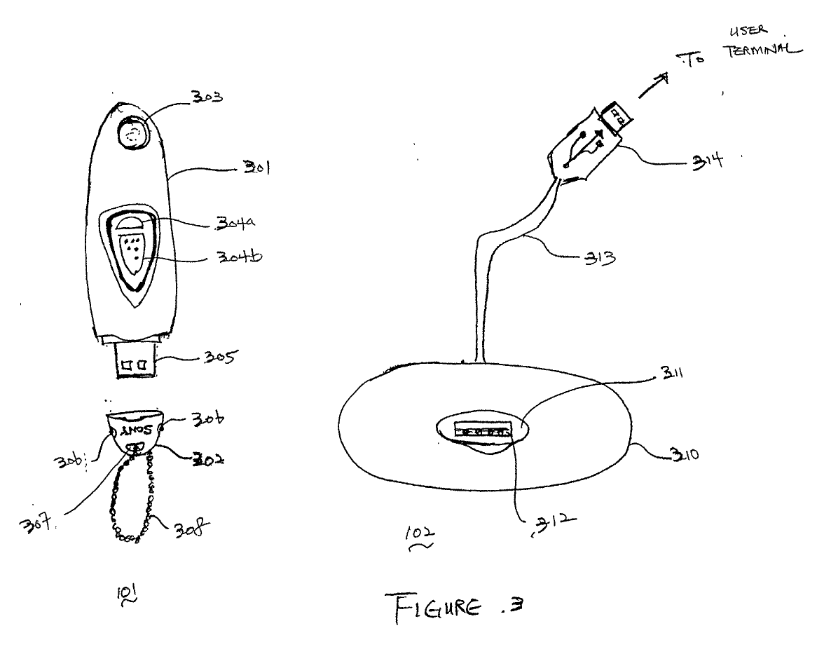

FIG. 3 illustrates an electronic music marker device and cradle-type docking connection of one embodiment. Referring to FIG. 3, music marker device 101 includes a housing comprising body 301 and cap 302. Body 301 is provided with e-mark button 303 which is configured for user input commands. Also provided on body 301 are display panels 304a and 304b which are configured to display the number of user inputted e-marks and the type of registered broadcast station for the corresponding e-marks, respectively. Finally, body 301 includes communication port 305 such as a USB port which is integrated onto body 301 such that, as will be discussed in further detail below, body 301 may be placed on top of cradle type connection 102 with communication port 305 capable of being plugged into the corresponding port on cradle 102.

Cap 302 can be attached to body 301 when access to communication port 305 is unnecessary. As shown, cap 302 is provided with a pair of release/lock buttons 306 on either side of cap 302 such that by depressing release/lock buttons 306 when cap 302 is locked with body 301, cap 302 can be released from a locked position and communication port 305 may be accessed. Furthermore, cap 302 is provided with hole 307 substantially at its edge position such that link chain 308 can be looped through hole 307 to allow the user to attach the music marker device 101 to a key chain or the like.

Referring back to FIG. 3, cradle-type connection 102 is provided with cradle base 310 substantially flat on its bottom surface (not shown) to rest cradle 102 on a flat surface such as a desktop and a book shelf. On the other side of the bottom surface of cradle 102 is receiving section 311 substantially positioned on the middle of cradle 102, where communication port 312 such as a USB port is provided for connection to communication port 305 of the music marker device 110. Also shown in FIG. 3 is cable 313 attached to cradle connection 102 with a communication port 314 at its other end. In this manner, cradle 102 may be connected to user terminal 103 accessing the user's e-marker account over an internet connection.

Additional detailed information relating to the operation of the electronic music marker device 110 may be found in pending application Ser. No. 09/126,007 filed on Jul. 29, 1998 and application Ser. No. 09/401,105 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

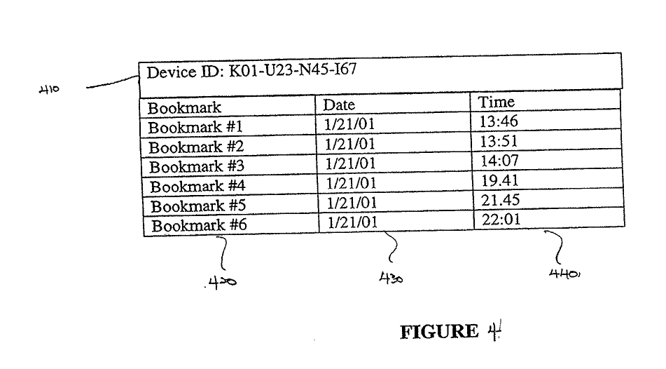

FIG. 4 is one embodiment of a database illustration of the bookmarks in a storage unit of the electronic music marker device. Referring to FIG. 4, storage unit such as a random access memory (RAM) and/or a read-only memory (ROM) may be configured to store device ID unique for each marker device 101 in device ID field 410. Additionally, storage unit of marker device 101 may also be configured to store bookmarks input by the user in bookmark field 420, with a corresponding date and time information (for example, a time stamp) for the respective bookmarks in date field 430 and time field 440, respectively. In this manner, when music marker device 101 is connected to server terminal 105 via user terminal 103, information stored in marker device storage unit such as the bookmarks and the corresponding date and time stamp information may be transmitted to server terminal 105.

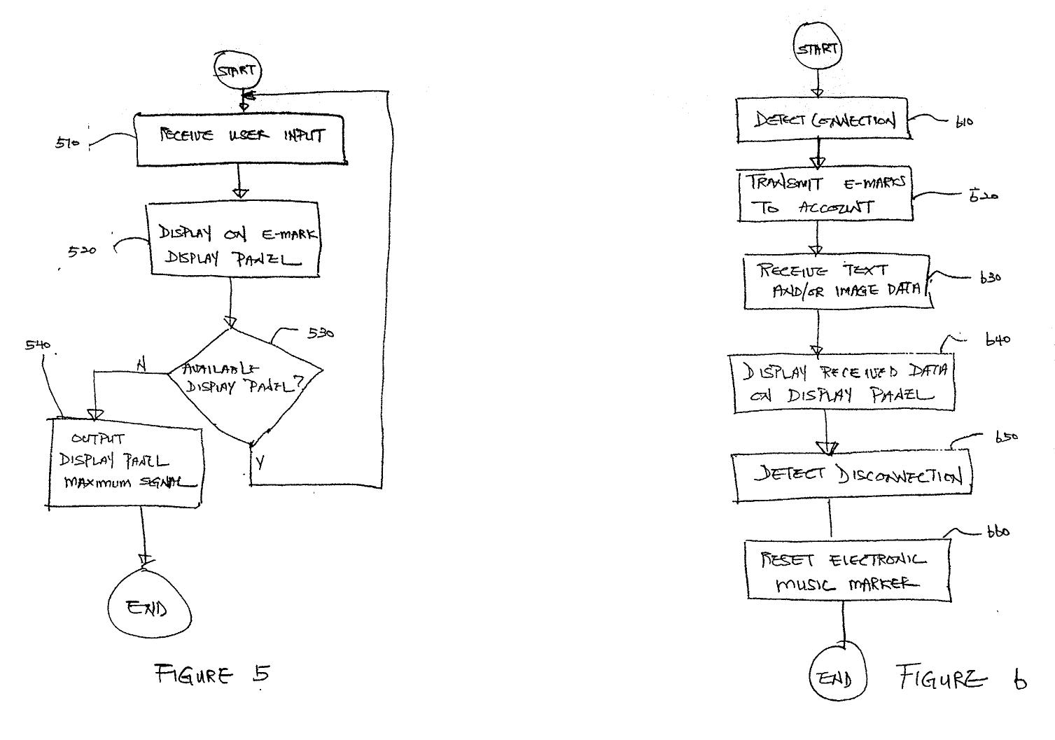

FIG. 5 is a flowchart for illustrating one embodiment of the electronic music marker device operation. Referring to FIG. 5, at step 510, electronic music marker device 101 detects user's input operation of e-mark buttons 203A, 203B. Then, at step 520, music marker device 101 illuminates or flashes a corresponding e-mark display panel 304a, 304b. As discussed above, in one embodiment, the corresponding e-mark display panel 304a, 304b may be configured to display time and/or date information of the user's input operation of e-mark buttons 203A, 203B.

At step 530, music marker 101 determines whether all available e-mark display panels 304a, 304b are being used (for example, illuminated or flashing in response to user's input operation of e-mark button 203A, 203B). If it is determined that there are e-mark display panels 304a, 304b available, music marker device 101 waits for further input operation by the user at step 510. On the other hand, if it is determined at step 530 that all available e-mark display panels 304a, 304b are in use, then at step 540, electronic music marker device 101 generates an output signal to inform the user that music marker device 101 has reached its maximum number of e-marks that it can handle, and the procedure ends. In one embodiment, the output signal from music marker device 101 to inform the user that it has reached its maximum number of e-marks it can handle may be an audible output signal such as an audible tone via an audio output terminal (not shown). Alternatively, music marker device 101 may be configured to flash all e-mark display panels 203A. 203B simultaneously for a predetermined period of time to visually indicate to the user that it has reached its maximum number of e-marks that it can handle.

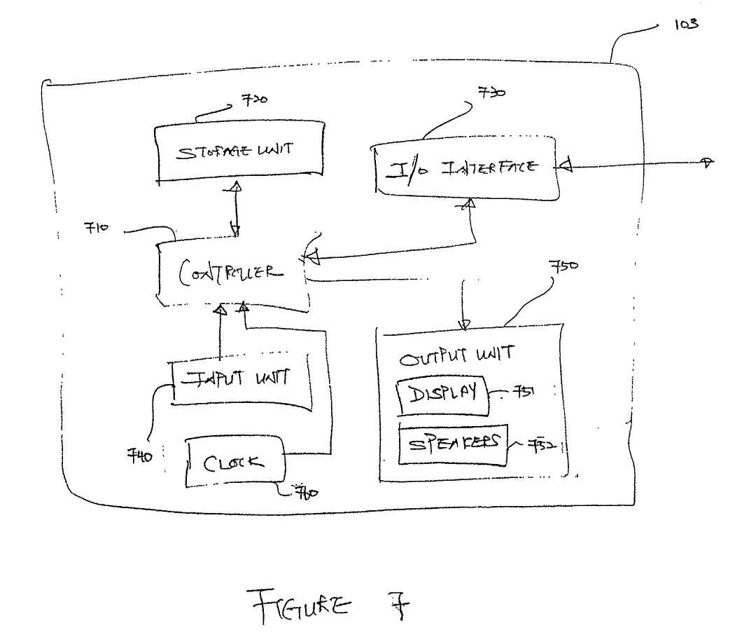

FIG. 6 is a flowchart for illustrating one embodiment of downloading data from the user's e-marker account to the music marker device. Referring to FIG. 6, at step 610, music marker device 101 detects a connection to user terminal 103 connected to the internet. After the user enters the user's account information and performing necessary e-marker account access steps at user terminal 103, at step 620, data corresponding to the e-marks (bookmarks) stored in music marker device 101 is transmitted to the user's e-marker account via gateway terminal 130, and in response, the corresponding text and/or image (including video) data are retrieved from server terminal 105 of e-marker.com web site and transmitted to the user's e-marker account. Then, at step 630, the text and/or image data corresponding to each e-marks are downloaded onto music marker device 101. At step 640, the downloaded text and/or image data are displayed on each corresponding e-mark display panel 304a, 304b on music marker device 101.

When the user disconnects music marker device 110 from user terminal 103, the termination of the is detected at step 650, arid at step 660, music marker device 101 is reset such that previously stored e-marks inputted by the user may be erased from the storage unit of music marker device 101, and correspondingly, the illuminated e-mark display panels 304a, 304b are turned off. The user may then operate e-mark button 203A, 203B again to input additional bookmarks of music clip broadcasts from registered radio and television broadcast stations.

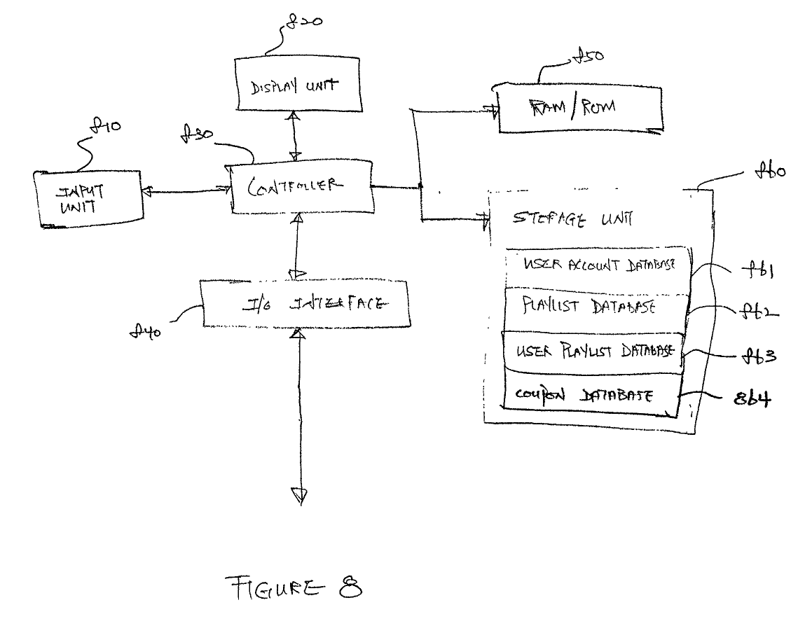

FIG. 7 illustrates one embodiment of a user terminal of the e-marker music find system. Referring to FIG. 7, user terminal 103 in one embodiment may include controller 710, storage unit 720, I/O interface unit 730, input unit 740, output unit 750 and clock 760. Storage unit 720 of user terminal 103 may include one or more of an internal or an external storage device such as a hard disc drive (HDD), a CD-RW drive, or a zip drive. Input unit 740 of user terminal 103 may include one of or a combination of a keyboard, a mouse, a touchpad input device and a voice-recognition type input terminal including a microphone with corresponding software installed in user terminal 103 for performing input operations by voice commands. Controller 710 is coupled to input unit 740 and accordingly, may be configured to process the input data received from input unit 740. Storage unit 720 is similarly coupled to controller 720, and may be configured to store inputted data received from input unit 740 or other data received by user terminal 103. Clock 760 also coupled to controller 710 may be configured to provide time information to controller 710 which, in turn, may be stored in storage unit 720 as discussed in further detail below.

Referring back to FIG. 7, I/O interface unit 730 in one embodiment may be coupled to controller 710, and may be configured to interface with other user terminals 103 in the network or to communicate with server terminal 105. In one embodiment, I/O interface circuit 730 of user terminal 103 may include a communication port configured to connect to the date network 104 such as the internet via connections such as, but not limited to, a modem dial-up through an internet service provider (ISP), a DSL or cable modem-type connection, and a T1, IDSN or LAN type connection. Communication port integrated in I/O interface circuit 230 may include, among others, one of a USB port, a serial port, a parallel port, an IEEE 1394 communication port, a IrDA communication port, and a Bluetooth enabled communication port.

Referring again to FIG. 7, output unit 750 of user terminal 103 may include display unit 751 and speakers 752. Display unit 751 may be configured to output text, image (for example, in .jpg or .gif formats) or video data (for example, in .avi or .mpeg formats) while speakers may be configured to output sound data in the form of, for example, .wav file format. In this manner, user terminal 103 in one embodiment may be configured to communicate with server terminal 105 over the internet connection 104.

FIG. 8 illustrates one embodiment of a server terminal in the e-marker dot promotion system. Referring to FIG. 8, server terminal 105 includes display unit 820, input unit 810, controller 830, input/output (I/O) interface unit 840, memory (RAM/ROM) 850, and storage unit 860. Display unit 820 may be configured to display various information including the status of server terminal 105 connection, data transfer processing status, data upload information, and any other information related to the operation of server terminal 105.

Input unit 810 of server terminal 105 may be configured to provide input means for operations such as server terminal maintenance, data backup, data query and so on. As can be seen, both display unit 820 and input unit 810 are coupled to controller 830. In one embodiment, controller 830 may be configured to control the display of information on display unit 820 in accordance with input operations received from input unit 810. Alternatively, server terminal 105 may exclude display unit 820.

Referring back to FIG. 8, controller 830 of server terminal 105 is further coupled to memory 850, storage unit 860 and I/O interface unit 840. In one embodiment, controller 830 may be configured to control data access, retrieval and updating of the stored data in storage unit 860. Moreover, controller 830 may further be configured to control the operation of I/O interface unit 840 which communicates with other terminals connected in the network over the internet connection 104. In one embodiment, I/O interface circuit 840 may include a communication port configured to connect to other terminals in the network via connections such as, but not limited to, a modem dial-up through an internet service provider (ISP), a DSL or cable modem-type connection, and a T1, ISDN or LAN type connection. Communication port integrated in I/O interface circuit 840 may include, among others, one of a USB port, a serial port, a parallel port, an IEEE 1394 communication port, a IrDA communication port, and a Bluetooth enabled communication port.

Referring again to FIG. 8, storage unit 860 of server terminal 105 may include internal or external storage devices such as a hard disc drive (HDD), a CD-RW drive, or a zip drive. In one embodiment, storage unit 860 may be configured to storage a variety of data received by server terminal 105 and processed by server terminal 105. In particular, storage unit 860 may include user account database 861, playlist database 862, user playlist database 863, and coupon database 864. User account database 860 as discussed in further detail below may be configured to store information related to the registered users of the e-marker system such as, for example, user name, address, account name, account password, and account status. Playlist database 862 may be configured to store playlists for each registered radio station broadcasts periodically received from playlist provider 106. Additionally, user playlist database 863 may be configured to store music clip broadcast playlists corresponding to the user's bookmarks.

Moreover, coupon database 864 may be configured to store information corresponding to music album and related merchandise vendors and the coupon information for the discounted sale of the music album CD or related merchandise. In one aspect, as discussed in further detail below, coupon database 864 may include expiration information for each product discount coupon defined for example, by a predetermined time frame from the time the user receives the coupon, a corresponding promotion code for each coupon, user preference information such as frequency of bookmarked broadcast stations, user classification group such as gender, age group, and geographic location of the users, where the user preference information in one embodiment comprising the basis of generating a product target criteria. In one aspect, the product target criteria may be provided to the merchandise vendors periodically such that the vendors may offer coupons for the merchandise based on the product target criteria. Indeed, merchandise vendors may reformulate the discount coupons for the particular music album CDs and related merchandise available to e-marker users based on frequency of bookmarked music clips, user age group, gender, as well as frequency of the user's visits to the vendor's on-line stores.

As further shown in FIG. 8, controller is coupled to memory 850 for accessing software and drivers for performing the various functions and processes of server terminal 105 for the e-marker fund music system. Indeed, in one embodiment, the e-marker dot promotion system may be embodied as a computer program developed using an object oriented language that allows the modeling of complex systems with modular objects to create abstractions that are representative of real world, physical objects and their interrelationships. However, it would be understood by one of ordinary skill in the art that the various embodiments as described herein may be implemented in many different ways using a wide range of programming techniques as well as general purpose hardware systems or dedicated controllers.

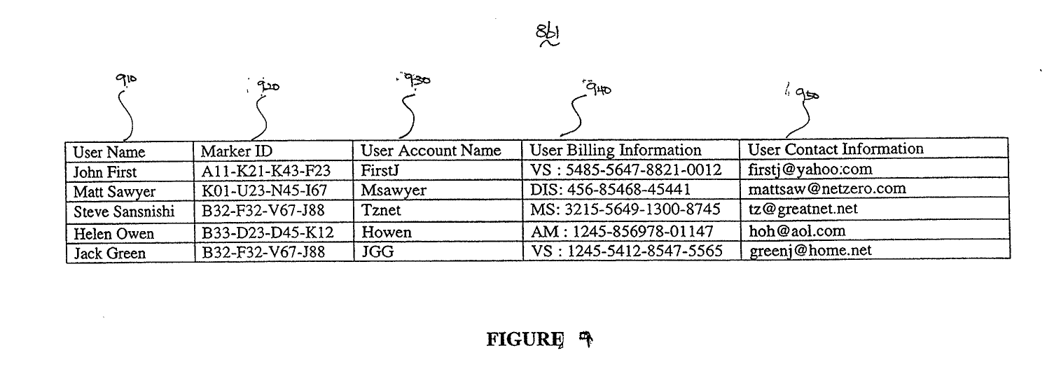

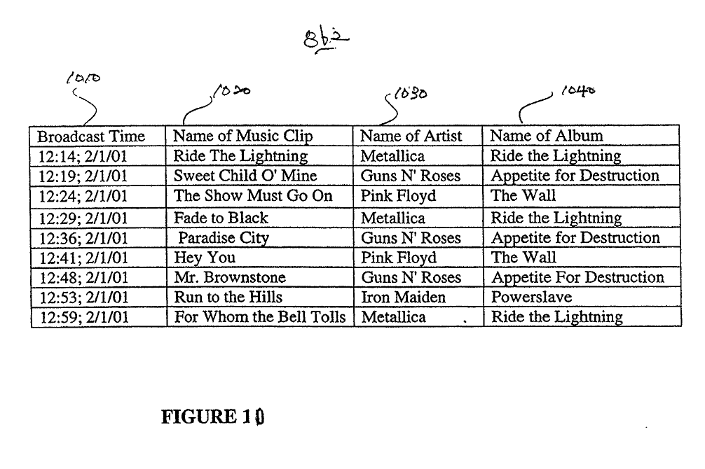

FIG. 9 illustrates a user account database of server terminal 105 storage unit 860 shown in FIG. 8. Referring to FIG. 9, user account database 861 may include a user name field 910, a marker identification (ID) field 920, a user account name field 930, a user billing information field 940, and a user contact information field 950. As can be seen from the figure, user name field 910 may be configured to store the name of the user of music marker device 101, while marker ID field 920 may be configured to store the music marker device ID corresponding to the respective device user name. For example, marker ID field 920 corresponding to the user John First may be configured to store the value “A11-K21-K43-F23” which corresponds to the marker device ID of John First. Moreover, marker ID field 920 corresponding to the user Matt Sawyer may be configured to store the value “K01-U23-N45-I67” as the marker ID for Matt Sawyer. In this manner, for each user and their respective electronic music marker devices, a unique marker ID may be stored in user account database 861.

Referring back to FIG. 9, user account name field 930 may be configured to store each user's account name, typically provided by the user, or alternatively, automatically assigned by the server terminal 105 (FIG. 1) upon user registration at the e-marker web site. For example, user account name field 930 corresponding to the user John First may include “FirstJ” indicating John First's account name. While the user account names stored in the user account name field 930 are shown as a combination of each user's initials and/or names, in one aspect, the user account name may be a combination of letters and number, a unique series of number, or any other data string which may uniquely identify the respective user.

As can be further seen from FIG. 9, user billing information field 940 may be configured to store billing information such as credit card number, expiration date, and the type of credit card for each user. For example, user billing information field 940 corresponding to the user Helen Owen may be configured to store the value “AM” indicating her American Express card, having a card number “1245-856978-01147”. In another aspect, user billing information field 940 may include the user's bank account information such as the user's bank account name, account number, and so on. Moreover, in other embodiments, the user billing information field 940 may include information corresponding to the user's transferable assets that the user wishes use as the preferred payment method for charges incurred, such as, for example, the user's frequent flier miles, the user's bank debit card, and so on.

Referring again to FIG. 9, user contact information field 750 may be configured to store contact information corresponding to each user. For example, in one aspect, user contact information field 950 may be configured to store email addresses of each respective user. Alternatively, user contact information field 950 may be configured to store a telephone number, a facsimile number, a pager number or any other type of contact information for the respective users. Moreover, user account database 861 may be further configured to store other relevant information corresponding to the users. In this manner, from the information stored in user account database 861, server terminal 105may retrieve information related to the respective user's account as well as to update the information stored in user account database 861 based on received playlists from playlist provider 106 and/or the users themselves who are updating their corresponding account.

FIG. 10 illustrates one embodiment of a playlist database of the server terminal data storage unit shown in FIG. 8. Referring to FIG. 10, playlist database 862 includes broadcast time field 1010, name of music clip field 1020, name of artist field 1030, and name of album field 1040 for storing broadcast information corresponding to music broadcasts from registered radio station having call number KROK. As can be seen, broadcast time field 1010 is configured to store the beginning of the broadcast time for the corresponding music clip as well as the date of broadcast, and each of name of music clip field 1020, name of artist field 1030, and name of album field 1040 is configured to store the corresponding name of the music, the name of the artist and the name of the album for the broadcast music clip.

Indeed, in one embodiment, for each registered radio station, playlist provider 106 may be configured to transmit information related to the broadcasted music to server terminal 105 within a predetermined time from the actual broadcast time. Server terminal 105 is then configured to store the received playlist information for each registered radio stations in storage unit 860. Server terminal 105 may also be configured to update playlist database 862 periodically or at each predetermined interval based on playlist information received from playlist provider 106 such that the data stored in playlist database 862 is maintained as up to date as possible. Furthermore, while only one playlist database 862 is shown in FIG. 8, in accordance with the present invention, server terminal 105 may be configured to generate, store and update a playlist database similar to that shown in FIG. 10 for each radio broadcast station. Moreover, within the scope of the present invention, additional data fields may be incorporated in playlist database 862. Such additional data may include, for example, the number of music clip broadcast over a predetermined time period such as the number of same song broadcast within one day, the frequency information corresponding to the radio station broadcasting the music clips, and the Billboard chart ranking for each broadcast music album.

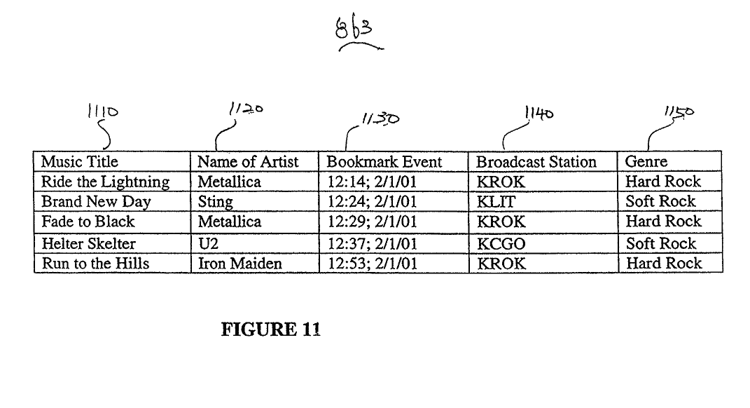

FIG. 11 illustrates one embodiment of a user playlist database of the server terminal data storage unit shown in FIG. 8. Referring to FIG. 11, playlist database 863 stored in server terminal 105 for user John First having user account name “FirstJ” includes music title field 1110, name of artist field 1120 corresponding to the name of the music title stored in music title field 1110, bookmark event field 1130, corresponding broadcast station field 1140, and genre field 1150.

As can be seen from the Figure, for each bookmark entered by John First using his electronic music marker device, once connected and synchronized with server terminal 105 via user terminal 103, information corresponding to the bookmarks are stored in the respective fields of user playlist database 863. For example, it can be seen from FIG. 11 that John First bookmarked the broadcast of the song titled “Ride the Lightning” by Metallica at 12:14 PM on Feb. 1, 2001, and that the song was broadcast from a radio station having call number KROK, the song classified in the hard rock category. In this manner, for each user of music marker device, server terminal 105 is configured to generate and store in user playlist database 862 information corresponding to the music broadcasts received from playlist provider 106 and the bookmarking information from each user's music marker device 101 via user terminal 103. Additionally, server terminal 105 may be configured to add additional data fields to user playlist database 863 as well as to modify and update user playlist database 863.

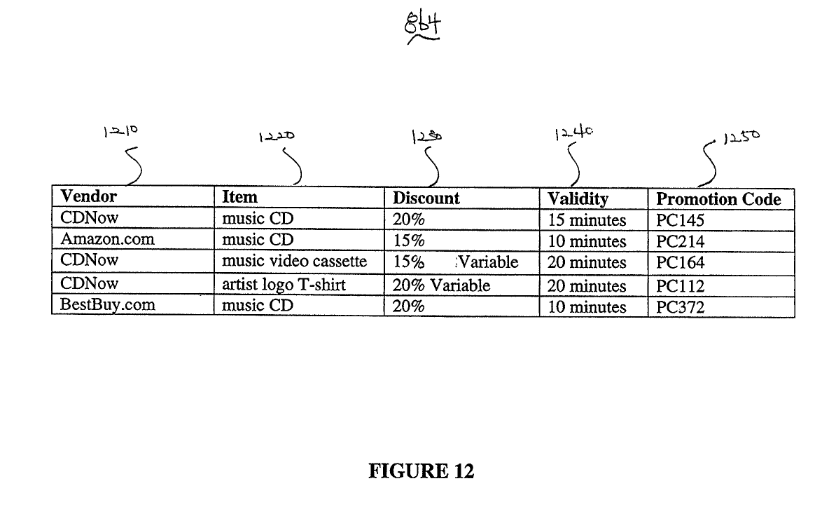

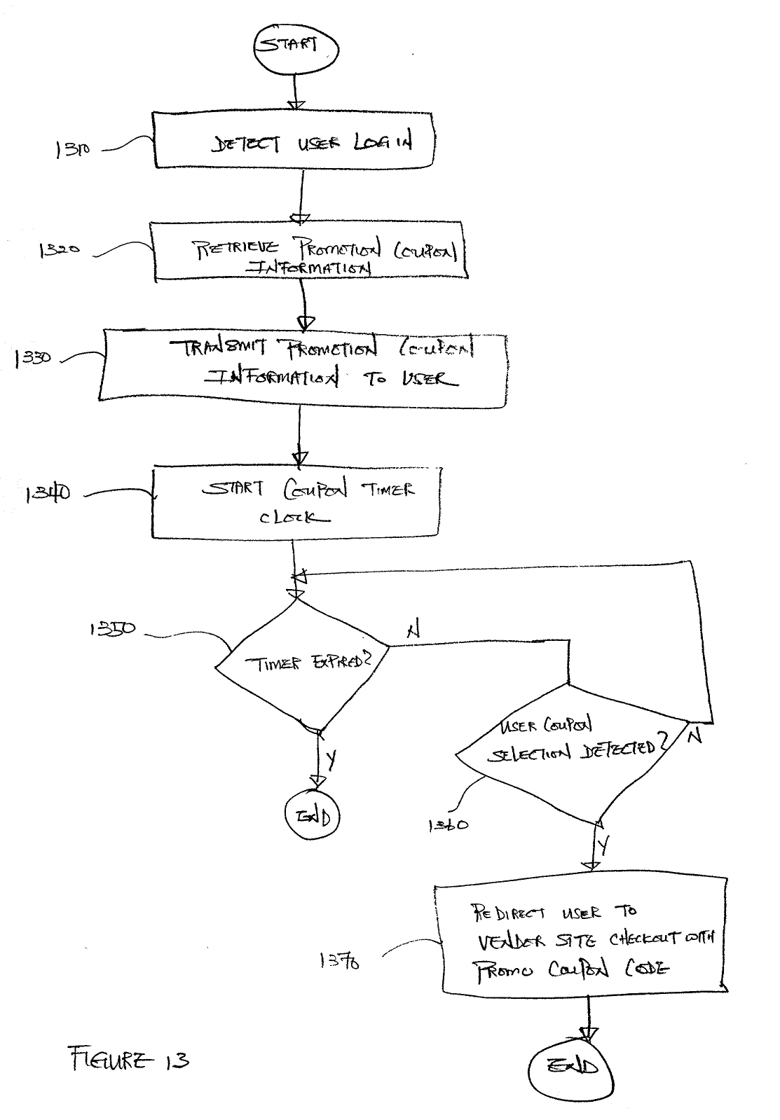

FIG. 12 illustrates one embodiment of a coupon database of the server terminal data storage unit shown in FIG. 8. Referring to FIG. 12, coupon database 864 in one embodiment includes vendor field 1210, item field 1220, discount information field 1230, coupon validity field 1240, and promotion code field 1250. As shown, vendor field 1210 may be configured to store vendor information of the music album CDs and/or related merchandise which may be offering a discount coupon for the purchase of bookmarked music album CD or related merchandise. For example, it can be seen from FIG. 12 that vendor field 1210 includes on-line vendors such as CDNow, Amazon.com, and BestBuy.com.

Referring to FIG. 12, item field 1220 corresponding to each vendor in vendor field 1210 may include the underlying item offered for sale with the discount coupon. For example, it can be seen from item field 1220 that items offered for sale by the vendors shown in FIG. 12 include music CDs, music video cassette and artist logo T-shirt. Discount field 1230 and validity field 1240 respectively include information corresponding to each discount coupon offered for the underlying item for sale. For example, as can be seen from FIG. 12, music CD offered for sale by vendor CDNow has a 20% discount as shown in the discount field 1230, which is valid for 15 minutes as shown in the corresponding validity field 1240.

In one aspect, the validity (or coupon expiration) information stored in the discount coupon validity field 1240 may include the time duration beginning from the user's receipt of the dot promotion discount offer, during which, the offered discount is valid if the user purchases the discounted item, for example, the music CD. Furthermore, the amount of offered discount may vary depending upon the vendor or the underlying merchandise offered for sale. For example, the dot promotion coupon offered to the users for the purchase of a particular music CD or a related merchandise may have a fixed percentage discount offer such as 20% or 15%. Alternatively, the dot promotion discount offers may be a variable percentage determined as a function of popularity or user request.

For example, it can be seen from FIG. 12 that the dot promotion coupon for the music video cassette from CDNow is offered at 15% Variable (discount field 1230) valid for 20 minutes (validity field 1240). In other words, the discount percentage for the music video cassette from CDNow may be offered initially at 15% off the retail price beginning at the 20 minute clock, and the discounted percentage may be configured to decrease within a predetermined time interval during the 20 minute clock, for example, by 5% for each lapsed 10 minute interval. In this manner, the buyers (or users of e-marker devices who wish to purchase the bookmarked music CDs or related merchandise) may be provided with an incentive complete the purchase transaction quickly rather than waiting until close to the expiration (or validity) of the dot promotion coupon offer.

In one aspect, when the buyer initiates the purchase transaction including the dot promotion coupon within the expiration time for the coupon offer, the promotion code stored in promotion code field 1250 for the particular item may be transmitted to the user for completing the purchase transaction with the corresponding vendor. Alternatively, the underlying promotion code for the particular purchase transaction may be automatically transmitted to the vendor site (for example, the web-site of the online vendor CDNow) such that the user is not required to enter the promotion code related to the dot promotion coupon offer at the vendor site to complete the purchase transaction.

Furthermore, coupon database 864 may be configured to be updated at a predetermined time interval such that expired dot promotion coupon offers are deleted from coupon database 864 while new offers from vendors are added to coupon database 864. More specifically, controller 830 may be configured to update coupon database 864 based on, among others, promotion information received from the various vendors. Furthermore, controller 830 may additionally be configured to add additional field to coupon database 864 such as target criteria field for particular promotion based on user's e-marker bookmarking history within a certain geographic region for specific music genre broadcasts, and any other information which may factor into the dot promotion coupon offers received from the vendors.

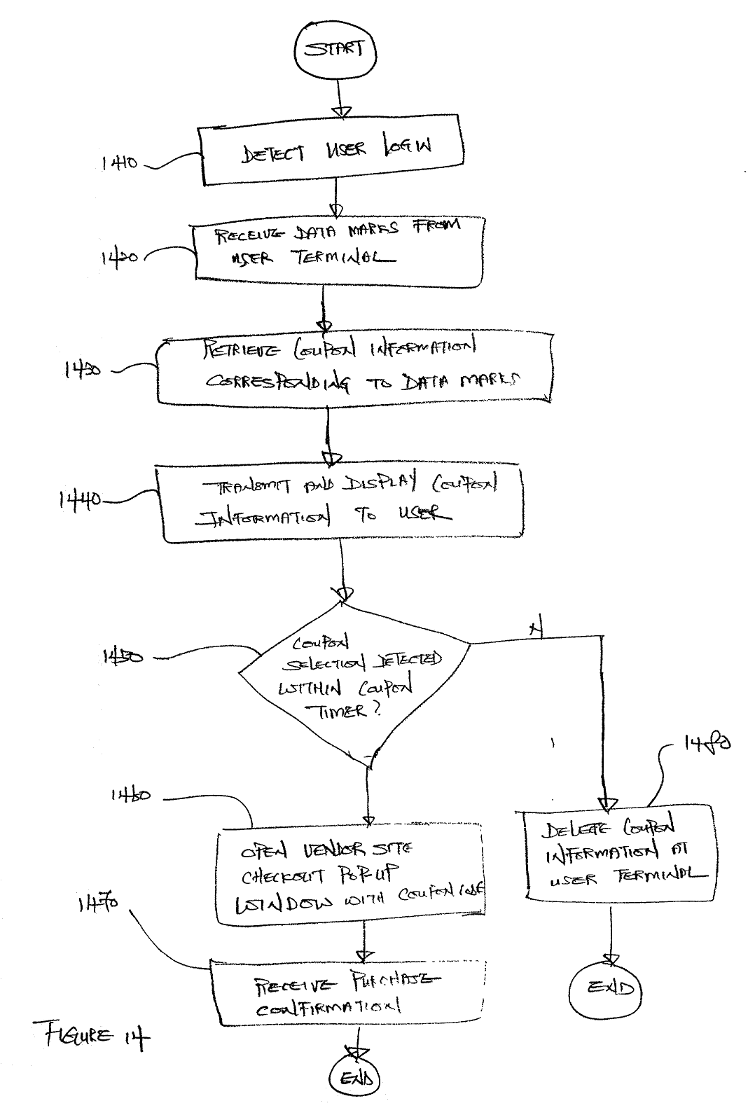

FIG. 13 illustrates a flowchart for illustrating a dot promotion processing of one embodiment. Referring to FIG. 13, at step 1310, server terminal 105 detects a user login and receives bookmarked information from user terminal 103. At step 1320, server terminal 105 may be configured to retrieve dot promotion coupon information corresponding to bookmarked music clips from coupon database 864, and to transmit the retrieved coupon information to user terminal 103 at step 1330. Thereafter at step 1340, server terminal 105 is configured to initiate the promotion coupon time clock based on the corresponding validity information stored in validity field 1240 of coupon database 864 for each transmitted coupon information. In one embodiment, server terminal 105 may be configured to display the countdown of the promotion coupon time clock on the display unit of user terminal 103. At step 1350, it is determined whether the promotion coupon time clock has expired, and if so, the processing terminates and the transmitted promotion coupon offer expires.

On the other hand, if at step 1350 it is determined that the promotion coupon time clock has not run and the dot promotion coupon offer is still valid, at step 1360 it is determined whether the user's coupon selection is detected, indicating that the user has initiated the purchase transaction of the offered item with the dot promotion coupon offer. If, however at step 1360 the user's coupon selection is not detected, then the processing returns to step 1350. With the detection of the user's coupon selection at step 1360, server terminal 105 is configured to re-direct the user to the vendor site corresponding to the dot promotion coupon offer to complete the user's purchase transaction. In one aspect, the user may be provided with the corresponding promotion code retrieved from promotion code field 1250 of coupon database 864 for manual entry during the user's checkout process at the vendor's online store. Alternatively, the corresponding promotion code may be directly transmitted to the vendor's online store checkout page.

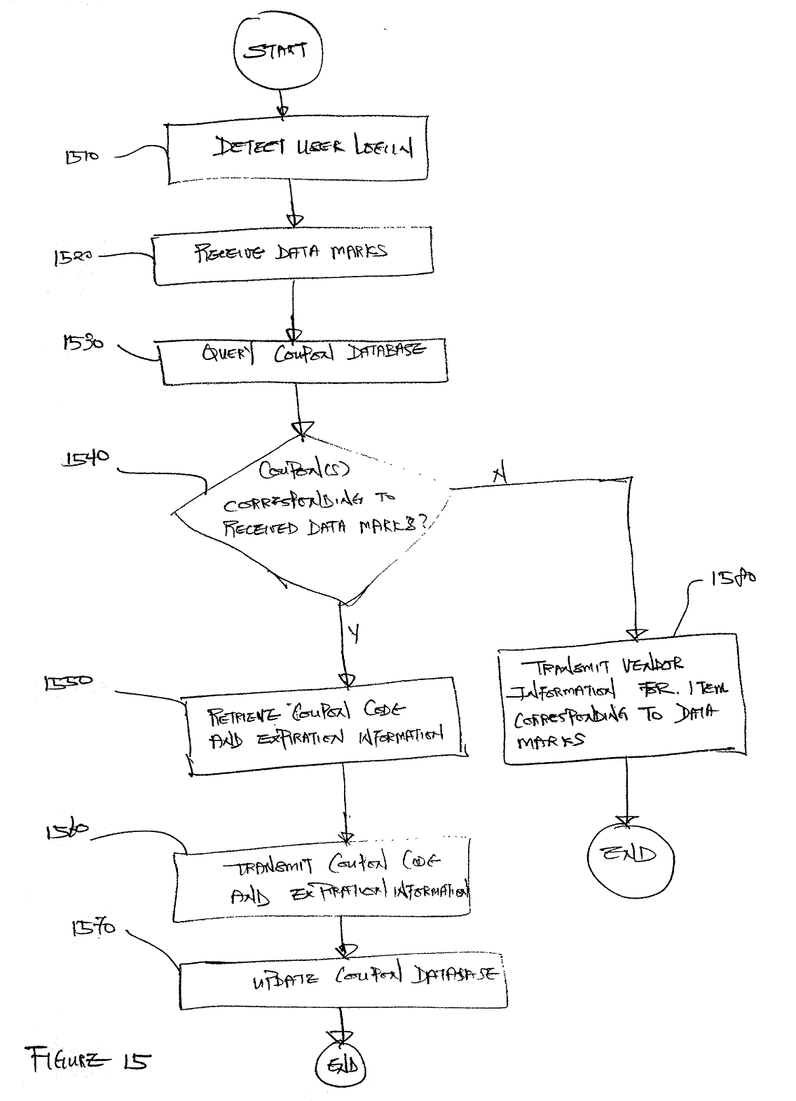

FIG. 14 illustrates a flowchart for illustrating a dot promotion processing of another embodiment. Referring to FIG. 14, at step 1410, e-marker user login from user terminal 103 is detected at server terminal 105. Thereafter, server terminal 105 receives data marks such as bookmarked music clips as well as data marker identification code from user terminal 103. At step 1430, controller 830 of server terminal 105 is configured to retrieve dot promotion coupon information corresponding to the received data marks by accessing and searching storage unit 860 of server terminal 105. In one aspect, controller 830 may be configured to retrieve all stored dot promotion coupon offers corresponding to the bookmarked music clips received from user terminal 103, including the particulars of each coupon offer such as the discount information retrieved from the corresponding discount field 1230 of coupon database 864, and validity information retrieved from the corresponding validity field 1240 of coupon database 864. For example, server terminal 105 may be configured to determine vendors that are offering discounts for music CDs and/or related merchandise corresponding to the user's bookmarked music clips.

Thereafter, server terminal 105 may be configured to retrieve the promotion coupon offers from each of the vendors and related information corresponding to the promotion offers. Having identified the available promotion coupon offers, server terminal 105 transmits the retrieved and identified coupon information to user terminal 103. In one aspect, the transmitted coupon information may be transmitted to user terminal 103 in a graphical format, a text format or a combination of graphical and text format including a selectable “dot” icon which is displayed on the user terminal 103 display unit, and which may be selected using an input device such as a keyboard, a mouse, or a stylus at user terminal 103.

Referring back to FIG. 14, at step 1450 server terminal 105 determines whether a coupon selection at user terminal 103 is detected within the validity time period of each coupon offer transmitted to user terminal 103. If at step 1450 it is determined that server terminal 105 did not detect any coupon offer selection at user terminal 103 within the validity time frame for each respective coupon offer, then at step 1480, server terminal 105 may be configured to delete the coupon information displayed at user terminal 103, and the processing terminates.

On the other hand, if at step 1450 server terminal 105 detects a user selection of a coupon offer within its validity time period transmitted to user terminal 103, then at step 1460, server terminal 105 is configured to open the corresponding vendor's online store site checkout page as a pop-up window displayed in user terminal 103 display unit, with the corresponding promotion code for the user selected coupon offer displayed thereon. Upon user's completion of the purchase transaction at the vendor's online store checkout page, a confirmation message may be transmitted to server terminal 105 at step 1470. Server terminal 105 may in one embodiment be configured to update coupon database 846 as well as the corresponding user account database 861 corresponding to the user who has executed the purchase transaction. Similarly, a purchase transaction confirmation message may be transmitted to user terminal informing the user (or purchaser) that the requested purchase transaction has been completed.

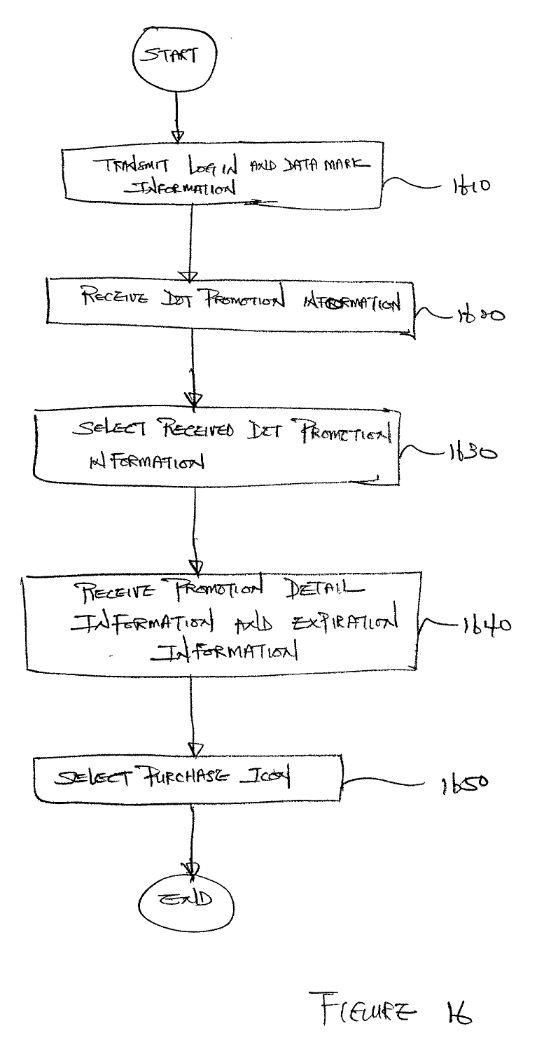

FIG. 15 illustrates a flowchart for illustrating a dot promotion processing a further embodiment. Referring to FIG. 15, upon detection of user login at step 1510 and receipt of user's data marks such as bookmarked music clips broadcast over registered radio and/or television station at step 1520, server terminal 105 may be configured to query coupon database 864 of storage unit 860. Thereafter at step 1540, it is determined whether there are dot promotion coupons corresponding to the received data marks. For example, controller 830 of server terminal 105 may be configured to query coupon database 864 based on data marks received as well as user data retrieved from user account database 861 and user playlist database 863 corresponding to the user who has transmitted the data marks.

Referring back to FIG. 15, if at step 1540 it is determined that there are no promotion coupons corresponding to the received data marks, then at step 1580, vendor information for the purchase of the item (such as music CDs) corresponding to the received data marks are transmitted to user terminal 103 with no corresponding promotion information, and the processing terminates. On the other hand, if at step 1540 it is determined that there are promotion coupons corresponding to the received data marks, then at step 1550, promotion coupon code and the corresponding expiration (or validity) information is retrieved from coupon database 864, and transmitted to user terminal at step 1560. Thereafter, at step 1570, coupon database 864 may be updated based on the processing at step 1550-1560.

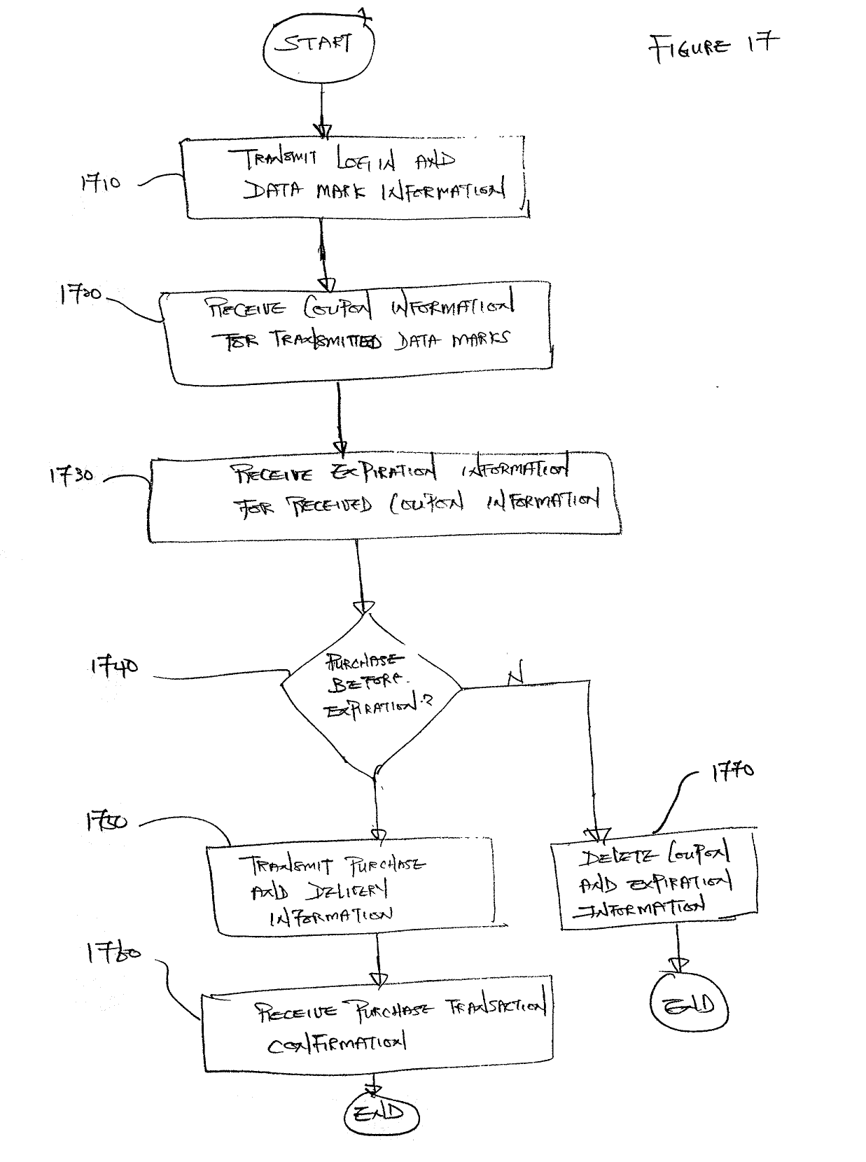

FIG. 16 illustrates a flowchart for illustrating a dot promotion processing of yet another embodiment. Referring to FIG. 16, at step 1610, an e-marker user connects the e-marker device to user (gateway) terminal 103 and transmits login information to server terminal 105 as well as bookmarked data marks such as bookmarked music clip information. At step 1620, dot promotion coupon information corresponding to the transmitted bookmarked data marks is received and displayed on user terminal display unit 751 (FIG. 7). At step 1630, using input unit 740 (FIG. 7), one or more of the desired promotion information is selected.

In one embodiment, the displayed promotion coupon information may be in a combined graphical and text format which is hypertext linked such that when the user selects the information at step 1640 using input unit 740 (which includes, for example, a computer mouse, a stylus pen, and the like), the corresponding information for the particular selected promotion coupon is displayed on display unit 751 of user terminal 103. Thereafter at step 1650, the user may select a purchase icon displayed on user terminal 103 display unit 751 to initiate the purchase transaction of the item with the promotion coupon.

As discussed above, the displayed promotion coupon information may be in combined graphical and text format. However, in other aspects of the present invention, the displayed promotion coupon information may also include sound data such as background music clip, as well as voice data which outputs the information related to the displayed promotion coupon at speakers 752 of user terminal 103. Furthermore, as will be discussed in further detail below, within the e-marker web domain, the promotion coupon information may be displayed in a “dot” format including text information displaying data corresponding to the promotion coupon and a graphical “dot” illustrated with the text information, and which may be selected by user using input unit 740.

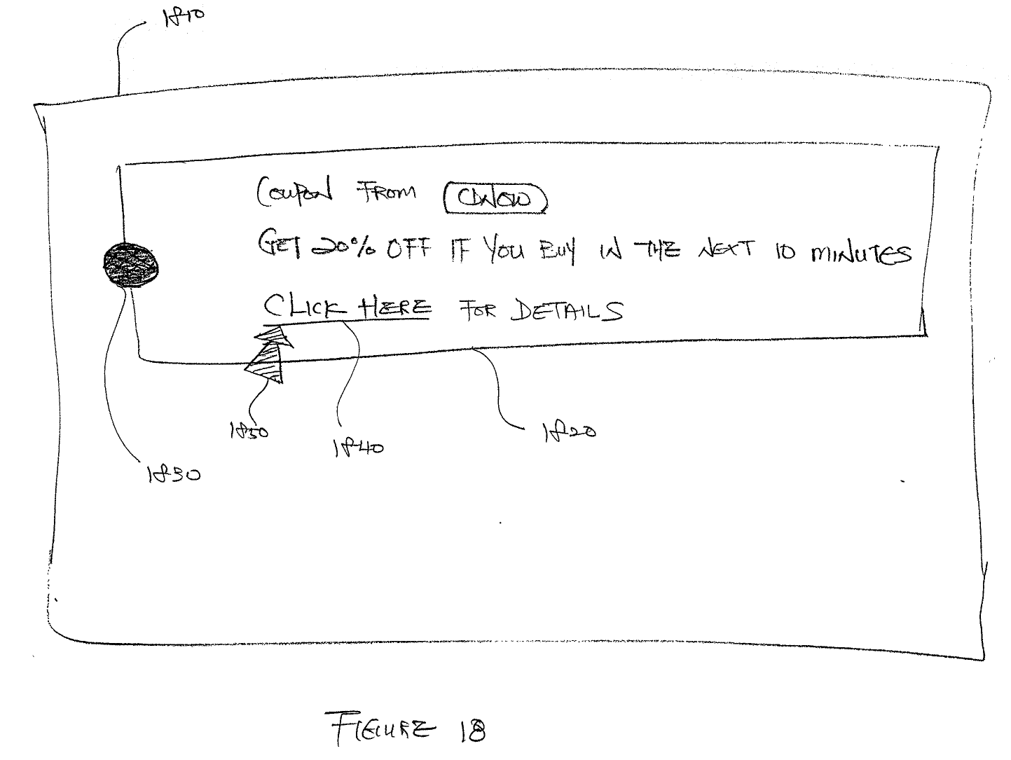

FIG. 17 illustrates a flowchart for illustrating a dot promotion processing of still a further embodiment. Referring to FIG. 17, at step 1710 login information for logging into user's e-marker account as well as bookmarked data marks are transmitted to server terminal 105. Thereafter, at step 1720, promotion coupon information corresponding to some or all of the transmitted data marks are received from server terminal 105, and at step 1730, validity or expiration information corresponding to each received promotion coupon information is received from server terminal 105.

In one aspect, the promotion coupon information and the corresponding expiration information may be received simultaneously from server terminal 105, this concurrently processing step 1720 and step 1730. Furthermore, expiration information corresponding to each received promotion coupon information may be displayed at user terminal 103 in the form of a continuously running clock (or timer) which begins to run from the time when the user receives the promotion coupon information from server terminal 105. In this manner, the user may be continuously informed of the exact amount of time during which the corresponding promotion coupon discount is valid.

Referring back to FIG. 17, at step 1740, it is determined whether the item corresponding to the received promotion coupon information will be purchased before the expiration time frame lapses. If at step 1740 it is determined that the item will not be purchased within the validity time period, and thus the validity time period lapses without a completed purchase transaction, then at step 1770, the promotion coupon information and the expiration information is deleted from user terminal, and the processing terminates.

On the other hand, if at step 1740, it is determined that the item will be purchased within the validity time period taking advantage of the discount offered by the promotion coupon, then at step 1750 purchase and delivery information is transmitted from user terminal 103 to complete the purchase transaction. In one embodiment, purchase information may include the user's credit card information such as credit card number, expiration date, as well as other medium for completing merchandise purchase on-line. Additionally, delivery information may include the desired delivery address for the delivery of the merchandise (or item) to be purchased with the discount offered by the promotion coupon. Moreover, in a further aspect, the purchase and delivery information may be transmitted to server terminal 105 for transmission to the respective vendor site, or alternatively, user terminal 103 may transmit the purchase and delivery information directly to the vendor's on-line store site such as Amazon.com. The latter approach avoids the extra step of processing the purchase and delivery information through, for example, e-marker.com's server terminal.

Referring again to FIG. 17, after transmitting the purchase and delivery information at step 1750, at step 1760, purchase information confirmation may be received at user terminal 103 informing the user that the executed purchase transaction has been completed. Furthermore, purchase information confirmation may also be transmitted to server terminal 105 for storage in storage unit 860 (FIG. 8).

In the manner described above, in accordance with various embodiments, electronic music marker device users may be provided with vendor promotion coupon information which provides discounted price for the purchase of bookmarked music clip CDs or related merchandise. Each promotion coupon for the particular item may be configured to expire after a predetermined time period, such incentive which may encourage the user to decide and purchase the desired item quickly rather than waiting. Moreover, the predetermined time period during which the promotion coupon is valid may be displayed on user terminal 103 display unit 751 as, for example, a clock counter, such that the user is continuously informed of the time remaining during which the promotion coupon would be valid.

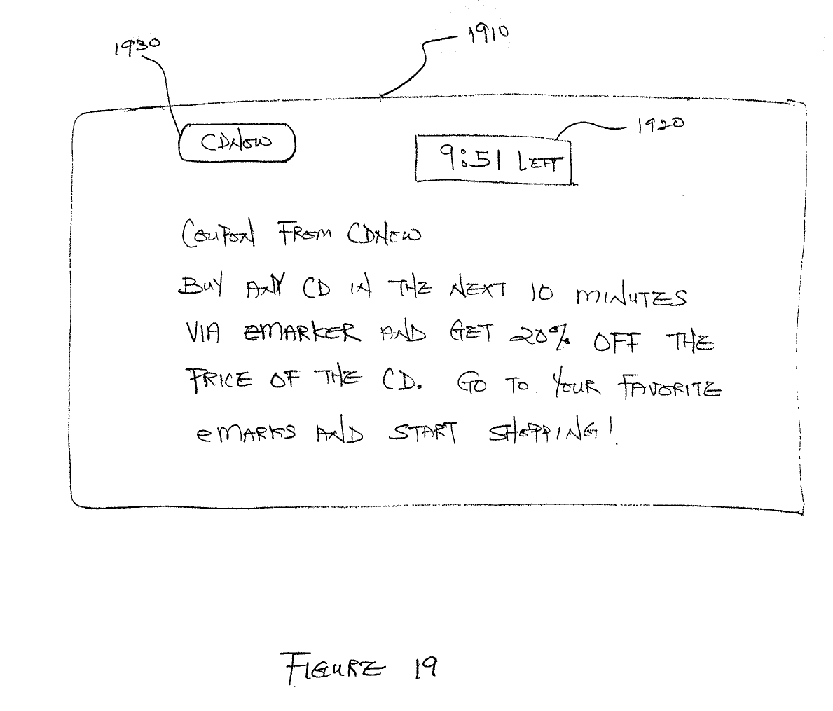

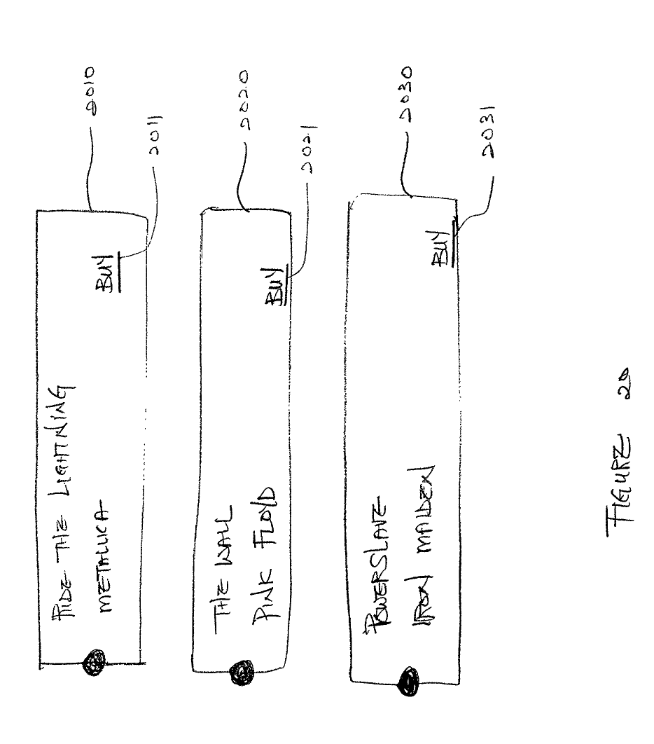

FIG. 18 is a graphical illustration of a user terminal display unit illustrating a dot promotion coupon offer in one embodiment. Referring to FIG. 18, there is shown a display screen 1810 of display unit 751 at user terminal 103. Within display screen 1810 is shown a promotion coupon 1820 including a graphical illustration of a “dot” 1830. As can be further seen from FIG. 18, the promotion coupon 1820 indicates a 20% off an item purchased from vendor CDNow if the purchase transaction is completed within 10 minutes. Also shown in promotion coupon 1820 is a hypertext link 1840 which, when selected using an input device such as a cursor 1850, a new display is shown in the user terminal display unit. This can be seen from FIG. 19 as discussed below.

FIG. 19 is a graphical illustration of a user terminal display unit illustrating detailed dot promotion coupon information in one embodiment. Referring to FIG. 19, as displayed on user terminal display unit, vendor information 1930 is displayed for the particular selected dot promotion coupon window 1910. Furthermore, the predetermined time period during which the promotion coupon is valid is illustrated as a graphical display of a running clock 1920. In one embodiment, clock display 1920 begins to run from the predetermined time period, or example, 10 minutes, when the user selects hypertext link 1840 (FIG. 8) for the particular promotion coupon and with the display of the selection dot promotion coupon information window 1910.

Referring back to FIG. 19, it can be seen that additional detailed information related to the purchase of the item (for example, music CD) is displayed in the dot promotion coupon information window 1910, which may be a pop-up window and displayed as such on user terminal 103 display unit 751. Furthermore, in one embodiment, in the case where the offered promotion discount percentage is variable, the indicated percentage off in the dot promotion coupon information window 1910 may be configured to refresh with the new discount percentage based on the elapsed time (or time remaining for the offer) as shown in the clock display 1920.

FIG. 20 is a graphical illustration of a user terminal display unit illustrating bookmarked music clip album dot promotion coupons in one embodiment. Referring to FIG. 20, as shown music CDs for the bookmarked music clips available from the particular vendor is displayed on user terminal 103 display unit 751. In particular, each available music CD from the vendor (for example, CDNow) corresponding to the user's bookmarked music clips are displayed in a “dot” promotion coupon format 2010, 2020, 2030, each including a respective purchase (or “buy”) hypertext link 2011, 2021, 2031. By selecting one of the purchase hypertext links 2011, 2021, 2031 using input unit 740 (FIG. 7) such as a computer mouse, a stylus pen, and the like, the user terminal 103 may be redirected to the vendor's online store checkout web page, or alternatively, the vendor's online store checkout web page may be displayed as a pop-up window in display unit 751 of user terminal 103.

In this manner, in accordance with various embodiments, users of electronic music marker devices may be provided with vendor discount coupon information each of which may include a validity time period, and displayed on user terminal as a corresponding “dot” promotion information. In one aspect, the user is required to complete the purchase transaction for the item or merchandise related to the bookmarked music clips offered for sale by the vendor within the predetermined validity time period. Accordingly, user terminals may be provided with “dot” promotion coupon information for the purchase of music CDs and related merchandise corresponding to the user's bookmarked music clips, while the users may be able to conveniently purchase the bookmarked music CDs and related merchandise at a discount from vendors through the e-marker.com web site.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method, comprising:
transmitting one or more data marks; and
receiving one or more promotion information corresponding to said one or more data marks.

2. The method of claim 1 wherein each of said one or more data marks includes a time stamp information.

3. The method of claim 1 wherein each of said one or more promotion information includes a predetermined expiration time period.

4. The method of claim 3 wherein said promotion information is not valid after said predetermined expiration time period elapses.

5. The method of claim 3 wherein each of said promotion information includes a discount information corresponding to a purchase of an item related to said one or more respective data marks.

6. The method of claim 5 wherein said discount information includes a discounted percentage of a retail purchase price of said item.

7. The method of claim 6 wherein said item includes one of a music CD, a music video cassette, an artist logo tee-shirt, and a music audio cassette.

8. The method of claim 1 further including:
selecting said one or more promotion information; and
receiving a confirmation message corresponding to said selected one or more promotion information.

9. The method of claim 8 wherein said confirmation message includes one or more of a discounted purchase price of an item corresponding to said selected one or more promotion information, and a delivery address.

10. The method of claim 8 wherein said selecting step includes transmitting a purchase information.

11. The method of claim 10 wherein said transmitted purchase information includes one of a credit card information, a web cash account information, a debit card information, and a checking account information.

12. A method, comprising:
connecting to a data network;
transmitting login information and a data mark;
receiving a promotion information for an item corresponding to transmitted data mark; and
transmitting a payment information.

13. The method of claim 12 wherein said connecting step including establishing one of one of a Local Area Network (LAN) connection, a Wide Area Network (WAN) connection, and a metropolitan area network (MAT) connection.

14. The method of claim 12 wherein said login information includes a predetermined user login data and a data marker device identification code.

15. The method of claim 14 wherein said data mark is stored in said data marker device.

16. The method of claim 14 wherein said data marker device includes an electronic music marker device.

17. The method of claim 12 wherein said promotion information includes a discount information for the purchase of said item.

18. The method of claim 17 wherein discount information includes a timed discount coupon.

19. The method of claim 18 wherein said timed discount coupon is configured to expire after a predetermined time period elapses.

20. The method of claim 19 wherein a value of said discount coupon is fixed during said predetermined time period.

21. The method of claim 19 wherein a value of said discount coupon decreases substantially proportionally the amount of said predetermined time period elapsed.

22. The method of claim 17 wherein said promotion information further includes vendor information for said item.

23. The method of claim 12 wherein said payment information includes one of a credit card information, a web cash account information, a debit card information, and a checking account information.

24. The method of claim 12 wherein said transmitted payment information corresponds to the purchase of said item.

25. The method of claim 12 further including receiving a confirmation information.

26. The method of claim 12 further including transmitting a delivery information for the delivery of said item.

27. A method, comprising:
receiving a user login data and a data mark;
retrieving a promotion information corresponding to said received data mark; and
transmitting said retrieved promotion information.

28. The method of claim 27 wherein said data mark includes a time stamp information.

29. The method of claim 27 wherein said promotion information includes a discount information corresponding to the purchase of an item related to said received data mark.

30. The method of claim 29 wherein said item includes one of a music CD, a music video cassette, and a music audio cassette.

31. The method of claim 29 wherein said promotion information further includes an expiration information corresponding to a validity time period of said discount information.

32. The method of claim 31 further including displaying said expiration information.

33. The method of claim 29 wherein said promotion information further includes a vendor information corresponding to the purchase of said item.

34. The method of claim 33 wherein said vendor information includes a hypertext link data corresponding to an on-line retail store of said vendor.

35. The method of claim 33 further including:
receiving a purchase request;
displaying purchase information of said item.

36. The method of claim 35 wherein said displaying step includes redirecting to an online web store corresponding to said vendor.

37. The method of claim 35 wherein displaying includes generating a pop-up window for displaying purchase information of said item from said vendor.

38. The method of claim 27 further including updating said promotion information.

39. The method of claim 27 further including receiving a confirmation information corresponding to a purchase transaction of said item.

40. The method of claim 27 further including:
receiving a plurality of promotion information from one or more vendors; and
storing said received plurality of promotion information.

41. A method, comprising:
detecting a user login request;
receiving one or more data marks;
retrieving promotion information based on said data marks corresponding to a purchase of an item;
transmitting'said retrieved promotion information; and
starting a timer corresponding to said retrieved promotion information.

42. The method of claim 41, wherein when a purchase request for said item is received prior to the expiration of said timer, transmitting vendor purchase information, and when a purchase request for said item is not received prior to the expiration of said timer, transmitting a promotion expired message.

43. The method of claim 42 wherein said transmitting said vendor purchase information includes displaying an online web store of said vendor for the purchase of said item.

44. The method of claim 43 further including receiving a purchase confirmation message.

45. The method of claim 44 further including updating a promotion database.

46. The method of claim 42 wherein said transmitting said vendor purchase information includes generating a pop-up window displaying an online web store of said vendor.

47. The method of claim 41 further including displaying said timer.

48. The method of claim 41 wherein said promotion information includes a promotion coupon code.

49. A data marking device vendor promotion system, comprising:
a data network;
a user terminal coupled to the data network configured to transmit a login data and a data mark; and
a server terminal coupled to a data network configured to access one or more storage units in response to said data mark received from said user terminal, and to retrieve and transmit a promotion information corresponding to said data mark to said user terminal.

50. The system of claim 49 wherein said data network includes one of a Local Area Network (LAN), a Wide Area Network (WAN), and a metropolitan area network (MAN).

51. The system of claim 49 wherein said user terminal includes one of a personal computer, an internet access enabled personal digital assistant, Wireless Application Protocol enabled mobile telephone, and an i-mode enabled mobile telephone.

52. The system of claim 49 wherein said user terminal and said server terminal are coupled to said data network using one of a TCP/IP protocol, and an Appletalk protocol.

53. The system of claim 49 wherein said user terminal includes a display unit, said display unit configured to display said promotion information received from said server terminal.

54. The system of claim 49 wherein said one or more storage units of the server terminal includes one or more user playlist databases and a coupon database.

55. The system of claim 54 wherein said server terminal is configured to update said coupon database at a predetermined time interval.

56. The system of claim 54 wherein each of said one or more user playlist databases includes information corresponding to the marked data corresponding to the respective users.

57. The system of claim 49 wherein said data mark includes time stamp information.

58. The system of claim 49 wherein said promotion information is displayed at said user terminal.

59. The system of claim 58 wherein said displayed promotion information includes a combination of graphical data and text data.

60. The system of claim 58 wherein said promotion information corresponds to a discounted purchase price of an item related to said data mark.

61. The system of claim 60 wherein said item includes one of a music CD, a music video cassette, a music audio cassette, and a music video DVD.

62. A data marking device vendor promotion system, comprising:
means for detecting a user login request;
means for receiving one or more data marks;
means for retrieving promotion information based on said data marks corresponding to a purchase of an item; and
means for transmitting said retrieved promotion information.

63. The system of claim 62, further including means for transmitting vendor purchase information when a purchase request for said item is received within a predetermined time period, and means for transmitting a promotion expired message when a purchase request for said item is not received within said predetermined time period.

64. The system of claim 63 wherein said transmitting means includes display means for displaying an online web store of said vendor for the purchase of said item.

65. The system of claim 64 further including means for receiving a purchase confirmation message.

66. The system of claim 65 further including means for updating a promotion database.

67. The system of claim 63 wherein said means for transmitting said vendor purchase information includes means for generating a pop-up window displaying an online web store of said vendor.

68. A program storage device readable by a machine, tangibly embodying a program of instructions executable by the machine to perform method steps for providing a data marking device vendor promotion, said method steps comprising;
detecting a user login request;
receiving one or more data marks;
retrieving promotion information based on said data marks corresponding to a purchase of an item; and
transmitting said retrieved promotion information.
